(19) United States
(12) Patent Application Publication
(10) Pub. No.: US 2013/0159656 A1
(43) Pub. Date: Jun. 20, 2013

(54) CONTROLLER, COMPUTER-READABLE RECORDING MEDIUM, AND APPARATUS

(71) Applicant: Hiroshi Koarashi, Takaoka (JP)

(72) Inventor: Hiroshi Koarashi, Takaoka (JP)

(73) Assignee: FUJITSU LIMITED, Kawasaki-shi (JP)

(21) Appl. No.: 13/609,630

(22) Filed: Sep. 11, 2012

(30) Foreign Application Priority Data
Dec. 15, 2011 (JP) 2011-274305

(51) Int. Cl. G06F 12/02

(52) U.S. Cl. 711/165; 711/E12.002

(57) ABSTRACT

A controller includes a memory that stores a program, and a processor that executes, based on the program, a procedure comprising, recording migration data from a source to a destination assigned to a plurality of storages based on information for indicating a position of a recording area which is between areas in which data is recorded in units of blocks, receiving a request to release at least one of the plurality of storages during data migration and migrating recorded data recorded in the at least one of the plurality of storages to other recording area formed in other storages of the plurality of storages, and releasing the at least one of the plurality of storages after migrating the recorded data.

### CROSS-REFERENCE TO RELATED APPLICATION

This application is based upon and claims the benefit of priority of the prior Japanese Patent Application No. 2011-274305, filed on Dec. 15, 2011, the entire contents of which are incorporated herein by reference.

### FIELD

The embodiments discussed herein are related to a controller, program, and storage unit.

### BACKGROUND

A technology for configuring RAID (redundant arrays of inexpensive disks) to provide redundant disk storage of a certain pattern is known. There is also a known technology for creating a hot spare disk against a failure of a disk included in RAID. If an active storage device fails, the failed storage device is logically replaced with a hot spare disk and the data is moved to the hot spare disk or created again.

A technology for creating a virtual hot spare from the unused storage areas of a plurality of storage devices included in a hot spare disk is known.

Japanese National Publication of International Patent Application No. 2008-519359 is an example of related art.

### SUMMARY

According to an aspect of the invention, a controller includes a memory that stores a program, and a processor that executes, based on the program, a procedure comprising, recording migration data from a source to a destination assigned to a plurality of storages based on information for indicating a position of a recording area which is between areas in which data is recorded in units of blocks, receiving a request to release at least one of the plurality of storages during data migration and migrating recorded data recorded in the at least one of the plurality of storages to other recording area formed in other storages of the plurality of storages, and releasing the at least one of the plurality of storages after migrating the recorded data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts a storage apparatus according to a first embodiment;

FIG. 2 depicts release processing according to the first embodiment;

FIG. 3 depicts a storage system according to a second embodiment;

FIG. 4 depicts functions of the storage system according to the second embodiment;

FIG. 5 depicts examples of a bitmap table;

FIG. 6 depicts addition of a bitmap table;

FIG. 7 depicts addition of a bitmap table;

FIG. 8 depicts an example of a control table;

FIG. 9 depicts RAID configuration change processing;

FIG. 10 depicts a specific example of RAID configuration change processing;

FIG. 11 depicts a specific example of RAID configuration change processing;

FIGS. 12A and 12B depicts a specific example of RAID configuration change processing;

FIG. 13 depicts a specific example of RAID configuration change processing;

FIG. 14 depicts processing during writing of data;

FIG. 15 depicts a specific example of processing during writing of data;

FIG. 16 depicts disk release processing;

FIG. 17 depicts a specific example of disk release processing;

FIG. 18 depicts disk addition processing;

FIG. 19 depicts a specific example of disk addition processing; and

FIG. 20 depicts data collection processing.

### DESCRIPTION OF EMBODIMENTS

First, changing of the RAID configuration using a virtual hot spare is discussed to consider related technologies. An increase in the number of hot spare disks included in a virtual host spare allows data to be read in parallel. Accordingly, if many hot spare disks are assigned to the virtual hot spare, the data migration time may be reduced. However, this degrades the preparation for a hot spare that arises in, for example, a failure of a disk in RAID.

When a disk failure occurs during data migration and a hot spare disk included in the virtual hot spare is assigned for recovery, the data migration is canceled. If the data migration is canceled, the part of the data migration processed before the cancellation comes to nothing. In addition, re-execution of data migration from the beginning increases the data migration time.

According to an embodiment described below, the number of storage units to which data is migrated reduces during data migration.

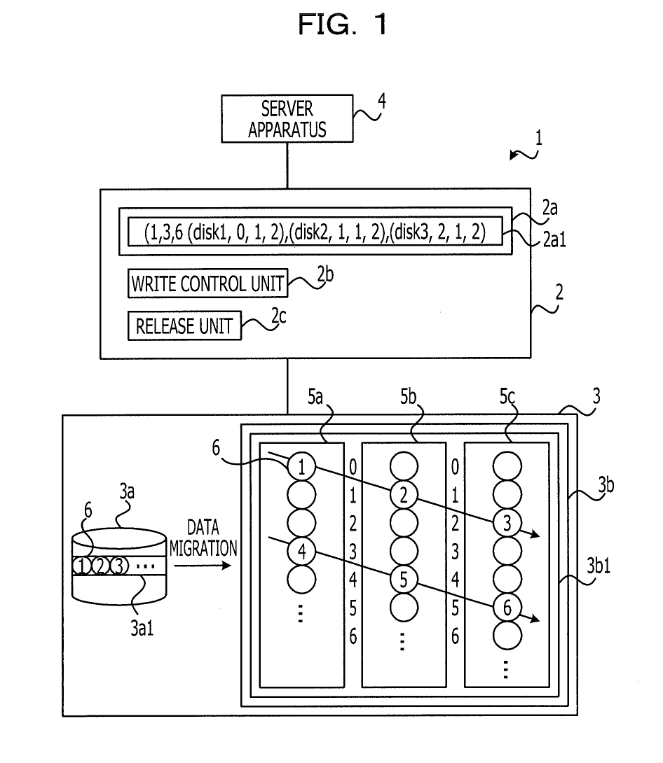

FIG. 1 depicts a storage apparatus according to a first embodiment.

The storage apparatus 1 according to the first embodiment includes a controller 2 and a storage unit set 3. The storage unit set 3 includes a plurality of physical storage units. An example of a physical storage unit is a hard disk drive (HDD), a solid state drive (SSD), etc. A logical storage unit 3a depicted in FIG. 1 is a logical storage unit created using the storage area of at least one of physical storage units included in the storage unit set 3. The logical storage unit 3a is a storage unit used by a server apparatus 4, which is coupled to the controller 2 through a network. An example of the logical storage unit 3a is an apparatus in which RAID is configured.

A virtual storage unit 3b is a storage unit temporarily created in the storage unit set 3 along with expansion of the storage area of the logical storage unit 3a. At least a part of the storage area of each of a plurality of physical storage units 5a, 5b, and 5c is assigned to the virtual storage unit 3b. When the storage area of the logical storage unit 3a is expanded, the controller 2 writes at least a part of the data stored in the logical storage unit 3a to a second storage area 3b1 to which at least a part of the virtual storage unit 3b is assigned. In the first embodiment, the controller 2 writes data stored in a first storage area 3a1 to the second storage area 3b1 in units of a given storage size (referred to below as a data block). Values within data blocks 6 are added for explanatory purposes. The data blocks 6 written to the second storage area 3b1 are collected in any of the physical storage units 5a, 5b, and 5c, the physical storage unit in which the data blocks 6 are collected is added to the logical storage unit 3a, and the storage area of the logical storage unit 3a is expanded.

The controller 2 has a function of migrating the data blocks 6 from the first storage area 3a1 of the logical storage unit 3a, which is the data migration source, to the second storage area 3b1, which is the data migration destination.

The controller 2 has a storage section 2a, a write control unit 2b, and a release unit 2c.

The storage section 2a stores a control table 2a1, which is related to a method of writing the data blocks 6 set for each of the physical storage units 5a, 5b, and 5c assigned to the virtual storage unit 3b. The storage section 2a may be implemented by the data storage area included in a RAM (random access memory) etc. incorporated in the controller 2. In addition, the write control unit 2b and the release unit 2c may be implemented by a CPU (central processing unit) included in the controller 2.

The items set in control table 2a1 from left to right are the data block number “1” with which a writing operation begins, the number “3” of the physical storage units 5a, 5b, and 5c assigned to the virtual storage unit 3b, which is referred to below as the unit count, the number “6” of data blocks written from the first storage area 3a1 to the second storage area 3b1, which is referred to below as the total write count, and write information of the physical storage units 5a, 5b, and 5c. The write information contains positional information, set so as to form and write a migration data recording area between data blocks 6, that indicates the position to which data block 6 is written. For example, the write information of the physical storage unit 5a contains “disk1”, which identifies the physical storage unit 5a, the write start position “0” in the second storage area 31b of the physical storage unit 5a, the number of data blocks 6 written at a time, which is referred to below as the data block count, and the number “2” of data blocks 6 that were written to the physical storage unit 5a, which is referred to below as the write count.

During data migration from the logical storage unit 3a to the virtual storage unit 3b, the write control unit 2b writes the data stored in the first storage area 3a1 to the second storage area 3b1 of the virtual storage unit 3b according to the write information of the physical storage units 5a, 5b, and 5c in the control table 2a1. A method of writing the data will be described below. The number of data blocks 6 written from the first storage area 3a1 of the control table 2a1 at the beginning of the writing operation to the second storage area 3b1 is “0” and the number of data blocks 6 written to each of the physical storage units 5a, 5b, and 5c is “0”.

The write control unit 2b calculates the write position in the physical storage unit 5a. The write position is calculated by “write start position”+“data block count”×“unit count”×“write count of physical storage unit 5a”=0+1×3×0=0. Similarly, the write position in the physical storage unit 5b is calculated by 1+1×3×0=1. The write position in the physical storage unit 5c is calculated by 2+1×3×0=2. In FIG. 1, the value between the physical storage units 5a and 5b and the value between the physical storage units 5b and 5c indicate the write position.

Next, the write control unit 2b writes data blocks of the size specified by the data block, beginning with the calculated write positions in the physical storage units 5a, 5b, and 5c. Upon completion of the writing operation, the write control unit 2b increments the write count of each of the physical storage units 5a, 5b, and 5c in the control table 2a1, by 1. This changes the write count of each of the physical storage units 5a, 5b, and 5c from 0 to 1. Upon completion of writing operation to the physical storage units 5a, 5b, and 5c, the write control unit 2b increments the total write count in the control table 2a1 by 3, which equals the unit count. This changes the total count from 0 to 3.

Next, the write control unit 2b calculates the write position in the physical storage unit 5a again. The write position is calculated by “write start position”+“data block count”×“unit count”×“write count”=0+1×3×1=3. Similarly, the write position in the physical storage unit 5b is calculated by 1+1×3×1=4. The write position in the physical storage unit 5c is calculated by 2+1×3×1=5.

FIG. 1 depicts the data blocks 6 written to the write positions. In the write method according to the first embodiment, the write positions in the physical storage units 5a, 5b, and 5c are shifted to each other during writing operations, so that the write positions do not overlap each other in the physical storage units 5a, 5b, and 5c in the second storage area 3b1. This forms a migration data recording area between data blocks 6 stored in each of physical storage units 5a, 5b, and 5c, thereby facilitating data saving described below.

When receiving a release request to release the physical storage unit 5b of the physical storage units 5a, 5b, and 5c assigned to the virtual storage unit 3b from the second storage area 3b1 of the physical storage unit 5b during data migration, the write control unit 2b performs release processing.

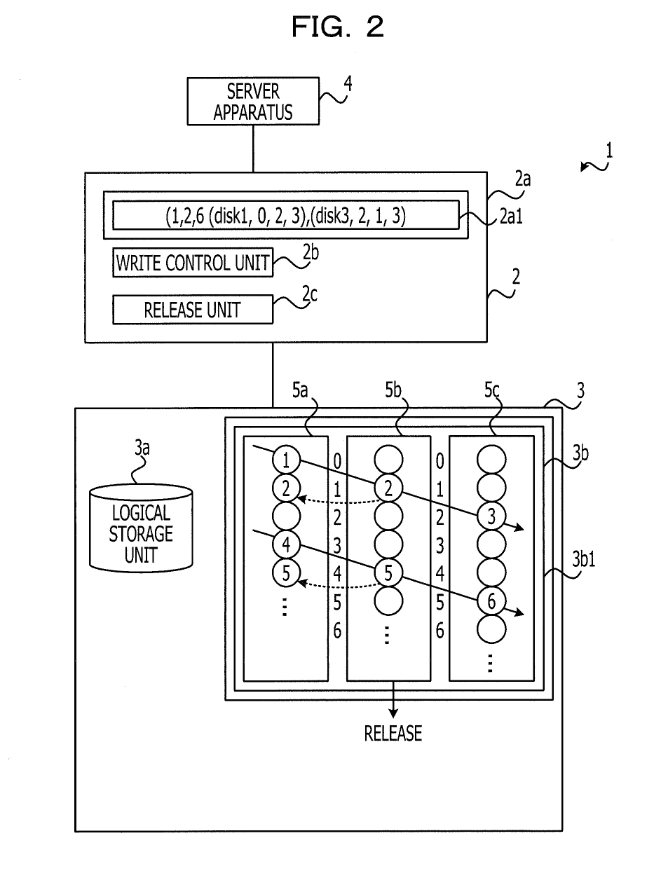

FIG. 2 depicts release processing according to the first embodiment.

In release processing, the data blocks stored in the physical storage unit 5b to be released are migrated to (saved in) the migration data recording area formed in the physical storage unit 5a, which is the other physical storage unit, assigned to the virtual storage unit 3b.

For example, the write control unit 2b reads the data block 6 written to the write position “1” in the physical storage unit 5b. Then, the write control unit 2b writes the read data block 6 to the write position “1” in the physical storage unit 5a. The write control unit 2b reads the data block 6 written in the write position “4” in the physical storage unit 5b. Then, the write control unit 2b writes the read data block 6 to the write position “4” in the physical storage unit 5a. After migrating all data blocks 6 written in the physical storage unit 5b to the physical storage unit 5a, the write control unit 2b deletes the information related to the physical storage unit 5b from the control table 2a1. Then, the write control unit 2b increments the data block count of the physical storage unit 5a in the control table 2a1 by 1 to 2 and decrements the value in the unit count field by 1 to 2. The control table 2a1 in FIG. 2 depicts a state in which disk release processing is completed.

Next, the release unit 2c releases the physical storage unit 5b. Then, the write control unit 2b continues data migration using the control table 2a1 depicted in FIG. 2.

According to the storage apparatus 1 in the first embodiment, even during data migration, the assignment to the virtual storage unit 3b may be changed in response to a decrease in the number of physical storage units 5a assigned to the virtual storage unit 3b. Accordingly, when data migration is carried out with the physical storage units 5a to 5c assigned to a hot spare disk, if a request to separately use the hot spare disk is accepted, the data migration may be continued by releasing the hot spare disk.

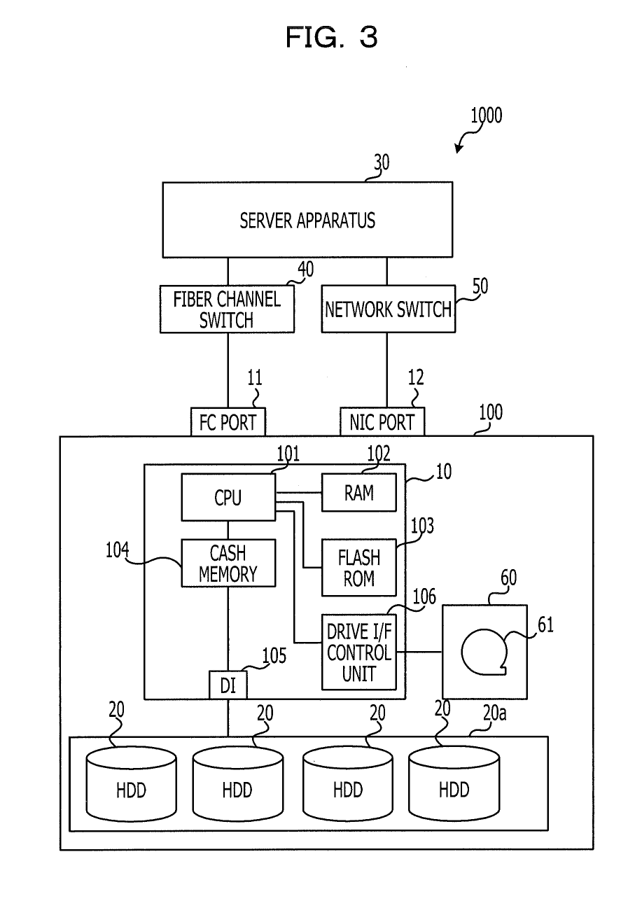

FIG. 3 is a block diagram depicting a storage system according to a second embodiment.

The storage system 1000 includes a server apparatus 30 and a storage apparatus 100, which is coupled to the server apparatus 30 via a fiber channel (FC) switch 40 and a network switch 50.

The storage apparatus 100 is a network attached storage (NAS) and has a drive enclosure (DE) 20a, which has a plurality of HDDs 20, and a control module 10, which manages the physical storage area of the drive enclosure 20a using RAID. The control module 10 is an example of a controller. In the second embodiment, HDDs 20 are used as storage media included in the drive enclosure 20a, but other storage media such as SSDs may also be used instead of HDDs 20. In the following descriptions, when the plurality of HDDs 20 included in the drive enclosure 20a are not distinguished from each other, they are referred to as the set of HDDs 20.

The number of control modules included in storage apparatus 100 is not limited to one, and two or more control modules may be used to provide redundancy for the set of HDDs 20. In the second embodiment, the storage apparatus 100 is a NAS, but the function of the control module 10 is applicable to other storage apparatuses such as SAN (storage area network) etc.

The control module 10 is coupled to a FC port 11 and a NIC port 12 via an internal bus.

The FC port 11 is coupled to the FC switch 40 and coupled, via the FC switch 40, to the server apparatus 30. The FC port 11 functions as an interface that transmits or receives data between the server apparatus 30 and the control module 10.

The NIC port 12 is coupled to the network switch 50 and coupled, via the network switch 50, to the server apparatus 30. Files are transmitted or received between the server apparatus 30 and the control module 10 through the NIC port 12 in protocols such as NFS (Network File System), CIFS (Common Internet File System), or HTTP (Hypertext Transfer Protocol).

The control module 10 includes a CPU 101, a RAM 102, a flash ROM (read only memory) 103, a cache memory 104, and a device interface (DI) 105.

The CPU 101 totally controls the entire control module 10 by executing a program stored in the flash ROM 103 etc.

The RAM 102 temporarily stores at least a part of an OS (operating system) programs or application programs executed by the CPU 101 and various types data to be used for processing by programs. The RAM 102 is an example of a storage section.

The flash ROM 103 a nonvolatile memory that stores OS programs or application programs executed by the CPU 101 and various types of data to be used to execute programs. If a power failure or the like occurs in the storage apparatus 100, the data stored in the cache memory 104 is saved in the flash ROM 103.

The cache memory 104 temporarily stores a file written to the set of HDDs 20 or a file read from the set of HDDs 20.

When, for example, receiving a file read command from the server apparatus 30, the control module 10 decides whether the file to be read is stored in the cache memory 104. If the file to be read is stored in the cache memory 104, the control module 10 transmits the file to be read to the server apparatus 30. The file may be transmitted to the server apparatus 30 faster than when the file to be read is read from the set of HDDs 20.

The cache memory 104 may temporarily stores files to be used for processing by the CPU 101. The cache memory 104 is, for example, a volatile semiconductor device such as SRAM (static RAM). The storage capacity of the cache memory 104 is not limited to a specific value, but it is approximately 2 GB to 64 GB, for example.

The device interface 105 is coupled to the drive enclosure 20a. The device interface 105 provides an interface function that transmitting or receiving files between the set of HDDs 20 included in the drive enclosure 20a and the cache memory 104. The control module 10 transmits files to or receives files from the set of HDDs 20 included in the drive enclosure 20a via device interface 105.

A drive I/F control unit 106 is coupled to a magnetic tape device 60 via a communication line such as a LAN. The drive I/F control unit 106 transmits data to or receives data from the magnetic tape device 60. The magnetic tape device 60 has a function of replaying data stored in a magnetic tape 61 and a function of storing data in the magnetic tape 61.

The control module 10 manages one block written to the magnetic tape 61 using one physical block ID. The type of the magnetic tape 61 is, for example, the LTO (Liner Tape Open) standard tape.

The above hardware structure achieves a processing function according to the second embodiment.

The storage apparatus 100 with the hardware depicted in FIG. 3 has the following functions.

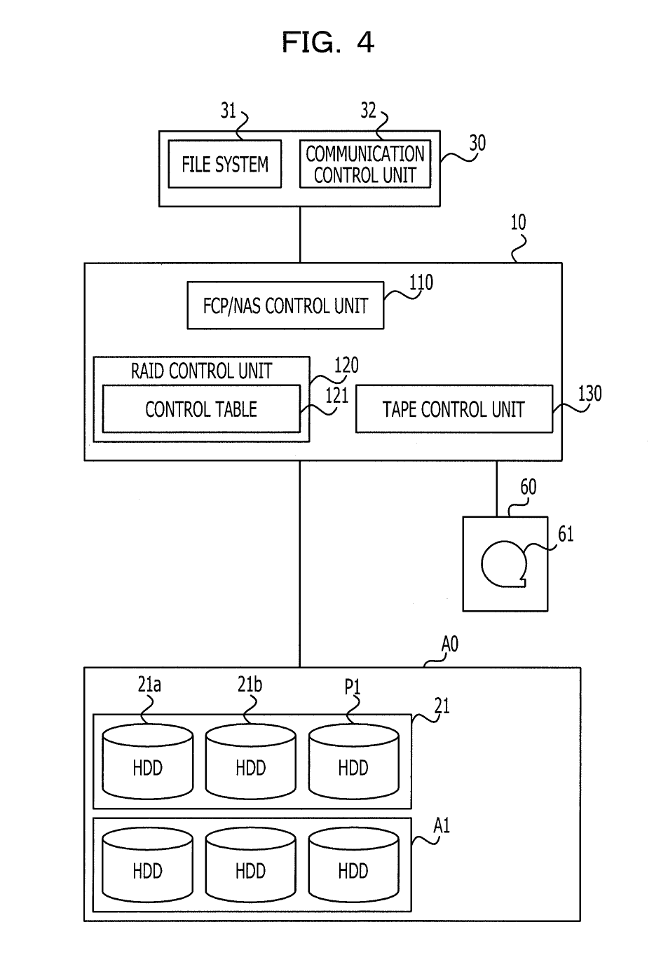

FIG. 4 is a block diagram depicting the functions of the storage system according to the second embodiment.

A storage pool A0 depicted in FIG. 4 is a physical storage area implemented by physical disks in the drive enclosure 20a.

The storage pool A0 has a RAID group 21 including one or more of the HDDs 20 of the plurality of HDDs 20 included in the drive enclosure 20a. This RAID group 21 may be referred to as a “logical volume”, “RLU (RAID logical unit)”, etc. The HDDs 20 included in the RAID group 21 are marked with different reference characters such as 21a, 21b, or P1 to distinguish them from other HDDs 20. A logical block (stripe) including a part of the storage area of each of the HDDs 21a, 21b, and P1 is set in the HDDs 21a, 21b, and P1 included in the RAID group 21. Access between the server apparatus 30 and the control module 10 is carried out in units of logical blocks. The RAID group 21 includes the two HDDs 21a and 21b, which store data divided in logical blocks and the HDD (parity disk) P1, which stores parity data, and is used in RAID4 (2+1).

The RAID configuration of the RAID group 21 is only an example, and is not limited to the RAID configuration in FIG. 4. For example, the RAID group 21 may include any number of HDDs 20. In addition, the RAID group 21 may be configured in any RAID level such as RAID6.

The storage pool A0 has a spare disk pool A1 including HDDs 20 in other than RAID group 21. The control module 10 may perform dynamic assignment of HDDs from the spare disk pool A1 to the RAID group 21. The HDDs in the spare disk pool A1 are referred to below as spare disks.

The server apparatus 30 includes a file system 31 and a communication control unit 32.

The server apparatus 30 recognizes, on the side of the server apparatus 30, the LUN (local unit number) of the RAID group as the storage area used by the server apparatus 30. Then, the server apparatus 30 makes partitions as occasion calls and applies the file system 31 of the OS of the server apparatus 30. The server apparatus 30 may read data from or write data to the RAID group 21 by transmitting an I/O request to the control module 10.

The file system 31 manages the storage area of the file system 31 in a bitmap format.

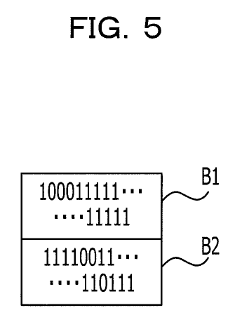

FIG. 5 depicts an example of the bitmap table.

One bit of a bitmap table B1 or B2 corresponds to one logical block. The bitmap table B1 stores the use conditions (presence or absence of data) of logical block addresses 0 to m. The bitmap table B2 stores the use conditions (presence or absence of data) of logical block addresses m+1 to n. The bit value of a logical block to which data accessed was made is set to 1.

The position in the bitmap table B1 or B2 identifies the order of the corresponding logical block from the beginning of the file system 31, so that whether the logical block is used or not may be checked.

The communication control unit 32 controls cooperation with the storage apparatus 100. The communication control unit 32 periodically monitors the file system 31. When, for example, the bitmap tables B1 and B2 of the file system 31 become full, the communication control unit 32 instructs the control module 10 to execute RAID configuration change processing, which will be described below. According to the instruction, the communication control unit 32 obtains the positions and sizes (logical block numbers and sizes of the file system) of tens of the largest free spaces in the file system 31 from the file system 31 and reports this information to the control module 10. When expanding the area of the file system 31, the file system 31 newly creates a bitmap table to manage the added area.

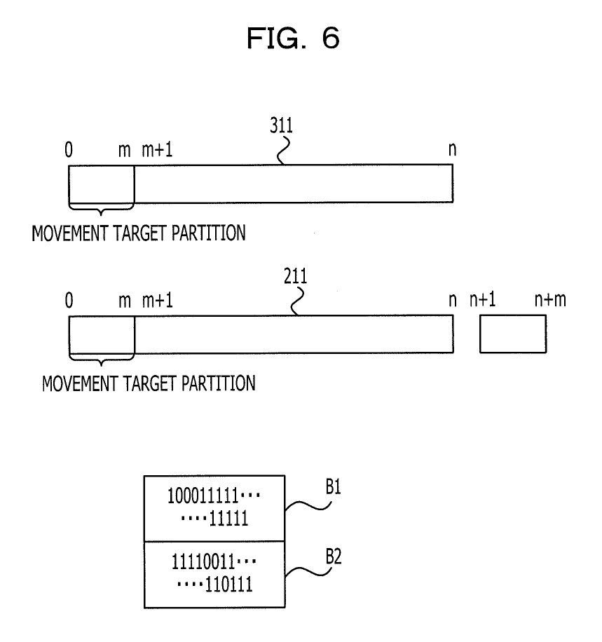

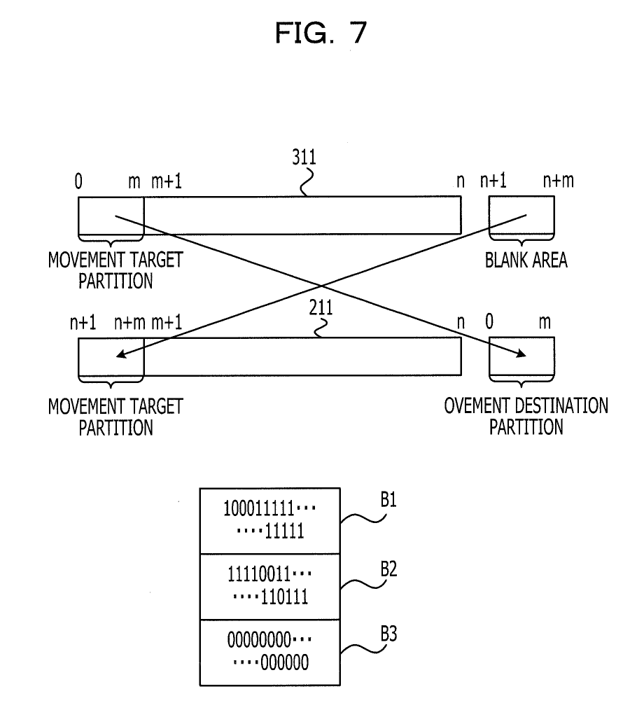

FIGS. 6 and 7 depict addition of a bitmap table.

FIG. 6 depicts a management area 311 of the file system 31, a management area 211 of the RAID group 21, and the bitmap tables B1 and B2 before RAID configuration change processing is performed.

In performing RAID configuration change processing, the file system 31 decides the area ranging from logical block address 0 to m to be a movement target partition.

According to an instruction from the server apparatus 30, a RAID control unit 120 prepares a movement destination partition ranging from logical block address n+1 to n+m, which stores the data stored in the movement target partition.

As depicted in FIG. 7, when the RAID control unit 120 performs RAID configuration change processing, the data stored in the movement target partition of the file system 31 is written to the prepared movement destination partition. The RAID control unit 120 requests the file system 31 to manage a blank area of the RAID group 21 that has become blank after the data is written to the movement destination partition. The file system 31 assigns the blank area of the RAID group 21 to logical block addresses n+1 to n+m of the file system 31. The file system 31a bitmap table B3, which manages logical block addresses n+1 to n+m to manage this blank area.

The description will continue with reference again to FIG. 4.

The control module 10 includes a FCP/NAS control unit 110, the RAID control unit 120, and a tape control unit 130. The RAID control unit 120 is an example of the write control unit and the release unit.

The FCP/NAS control unit 110 performs the I/O control of FCP/NAS for the LUN identified by the server apparatus 30 with respect to the RAID control unit 120.

The RAID control unit 120 controls HDDs included in the RAID group 21. For example, when receiving an I/O request for the RAID group 21 from the FCP/NAS control unit 110, the RAID control unit 120 performs a write operation so as to provide data redundancy based on setting information about RAID.

When receiving a data read request from the FCP/NAS control unit 110, the RAID control unit 120 identifies the addresses for indicating a read area. The RAID control unit 120 sends, to the server apparatus 30, the data read from the addresses indicating a read area.

The RAID control unit 120 manages the HDD 20, which is present in the spare disk pool A1.

In addition, the RAID control unit 120 performs processing (referred to below as RAID configuration change processing) for changing the RAID configuration of the RAID group 21 according to an instruction from the server apparatus 30. When performing RAID configuration change processing, the RAID control unit 120 creates a virtual disk based on one or more spare disks in the spare disk pool A1 to which data of the RAID group 21 is migrated. In RAID configuration change processing, the RAID control unit 120 migrates a part of data stored in the RAID group 21 to the created virtual disk by using the control table 121. The control table 121 is created by the RAID control unit 120. After that, the RAID control unit 120 collects the data in one of the spare disks included in the virtual disk. Then, the RAID control unit 120 incorporates the spare disk in which the data is collected into the RAID group 21.

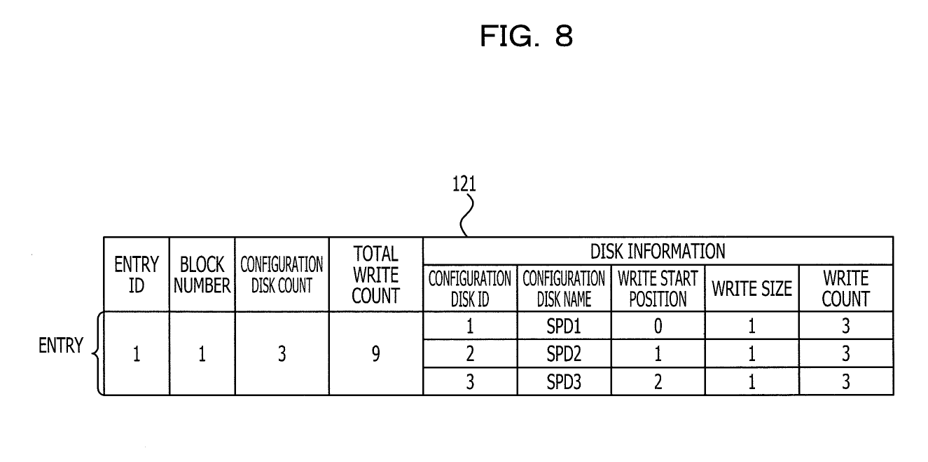

FIG. 8 depicts an example of the control table.

The control table 121 includes an entry ID field, a block number field, a configuration disk count field, a total write count field, and a disk information field.

An ID for managing the entry (record) is set in the entry ID field.

A block number with which a writing operation begins with the entry is set in the block number field.

The number of spare disks included in the virtual disk is set in the configuration disk count field.

The number of data items written to the virtual disk in units of logical blocks is set in the total write count field. Spare disks included in the virtual disk are referred to below as configuration disks.

Information about configuration disks to which data read from the RAID group 21 in units of logical blocks is written is set in the disk information field. For example, the disk information field includes a configuration disk ID field, a configuration disk name field, a write start position field, a write size field, and a write count field.

An ID identifying a configuration disk is set in the configuration disk ID field.

The disk name of a configuration disk to which data read in units of logical blocks is written is set in the configuration disk name field.

The position in the disk with which a data write operation begins is set in the write start position field.

The number of data items written at a time in units logical blocks is set in the write size field.

The number of times data read in units of logical blocks is written to the configuration disk is set in the write count field. The sum of the values set in the write count fields in the disk information field coincides with the value in the total write count.

The description will continue with reference again to FIG. 4.

The tape control unit 130 controls magnetic tape using the Linear Tape File System (LTFS) etc. For example, the tape control unit 130 instructs the magnetic tape device 60 to read or write data according to an instruction from the server apparatus 30. The magnetic tape device 60 writes data to or read data from the mounted magnetic tape 61 in units of logical blocks according to the instruction. One block is, for example, 32 kilobytes.

Next, processing by the control module 10 during RAID configuration change processing will be described below.

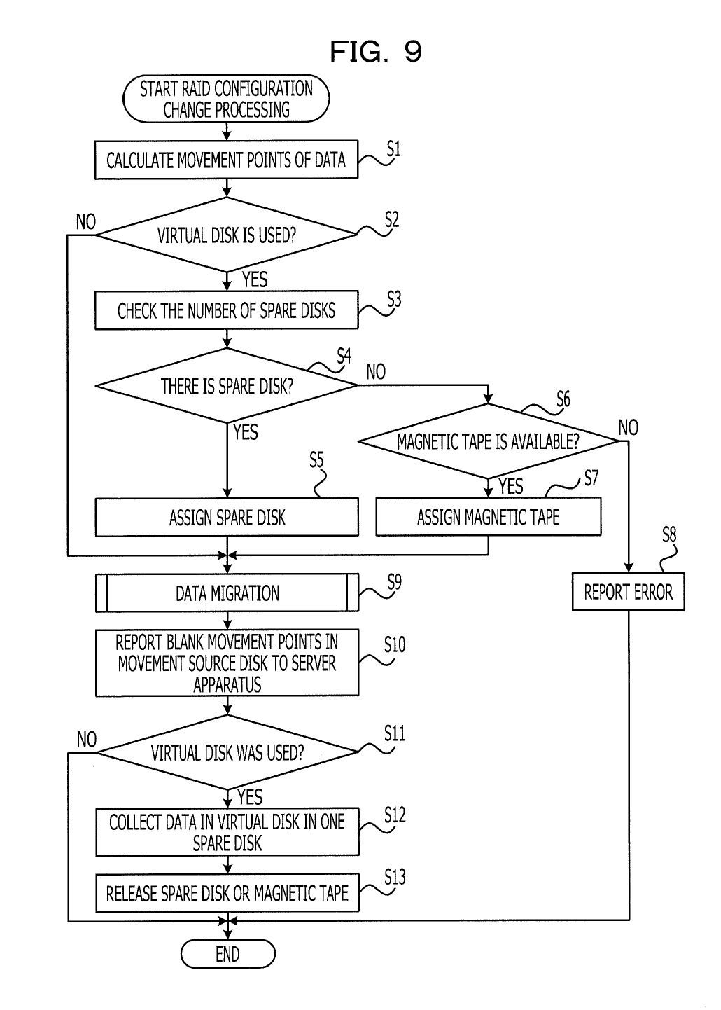

FIG. 9 is a flowchart depicting RAID configuration change processing.

[Step S1] The RAID control unit 120 calculates the movement points of data of configuration disks constituting the RAID group 21 using a finally-created RAID configuration specified by the designer. For example, the RAID control unit 120 checks to which area of the RAID group 21 the area of the file system 31 corresponds using free space information of the file system 31 received from the communication control unit 32. Then, the processing proceeds to step S2.

[Step S2] The RAID control unit 120 asks the server apparatus 30 via the communication control unit 32 whether a virtual disk is used. The server apparatus 30 decides whether a virtual disk is used, with reference to the file system 31. The server apparatus 30 returns a decision result to the RAID control unit 120. The RAID control unit 120 decides whether a virtual disk is used, based on the decision result by the server apparatus 30. When a virtual disk is used (Yes in step S2), the processing proceeds to step S3. When a virtual disk is not used (No in step S2), the processing proceeds to step S9.

[Step S3] The RAID control unit 120 checks the number of spare disks in the spare disk pool A1 using the decision result. Then, the processing proceeds to step S4.

[Step S4] The RAID control unit 120 decides whether there is a spare disk in the spare disk pool A1. When there are spare disks in the spare disk pool A1 (Yes in step S4), the processing proceeds to step S5. When there are no spare disks in the spare disk pool A1 (No in step S4), the processing proceeds to step S6.

[Step S5] The RAID control unit 120 collects a specified number of spare disks from spare disks in the spare disk pool A1. Then, the RAID control unit 120 creates one virtual disk in which all data storage areas are initialized to 0 by using the collected spare disks. Then, the RAID control unit 120 incorporates the created virtual disk into the RAID group 21. In addition, the RAID control unit 120 reports information about the incorporated virtual disk to the server apparatus 30. Then, the processing proceeds to step S9. The server apparatus 30 updates the file system 31 using the reported information about the virtual disk.

[Step S6] The RAID control unit 120 asks the tape control unit 130 whether the magnetic tape 61 is available. When the magnetic tape 61 is available (Yes in step S6) based on the query result referenced by the RAID control unit 120, the processing proceeds to step S7. When the magnetic tape 61 is not available (No in step S6), the processing proceeds to step S8.

[Step S7] The RAID control unit 120 assigns the storage area of the magnetic tape 61 to the virtual disk. Then, the processing proceeds to step S9.

[Step S8] The RAID control unit 120 reports an error to the server apparatus 30. Then, the RAID control unit 120 terminates RAID configuration change processing.

[Step S9] The RAID control unit 120 carries out data migration to equalize the free areas of the disks constituting the RAID group 21 for which the configuration change has been carried out. In data migration using a virtual disk, the RAID control unit 120 migrates the data stored in the movement points of data obtained in step S1 to the virtual disk. Data migration using a virtual disk will be described in detail below. When data migration is completed, the processing proceeds to step S10.

[Step S10] The RAID control unit 120 reports the movement points that are blank because data has been moved during data migration, to the server apparatus 30 via the communication control unit 32. Then, the processing proceeds to step S11. When receiving the report, the server apparatus 30 updates the file system 31.

[Step S11] The RAID control unit 120 decides whether a virtual disk was used. When a virtual disk was used (Yes in step S11), the processing proceeds to step S12. When a virtual disk was not used (No in step S11), RAID configuration change processing ends.

[Step S12] The RAID control unit 120 collects the data stored in the virtual disk in one of the spare disks constituting the virtual disk. Then, the RAID control unit 120 incorporates the spare disk in which the data is collected into the RAID group 21. Then, the processing proceeds to step S13.

[Step S13] The RAID control unit 120 releases the spare disks other than those incorporated into the RAID group 21 of the spare disks assigned to the virtual disk. If the magnetic tape 61 is incorporated into the virtual disk, the magnetic tape 61 is released. After that, RAID configuration change processing ends.

Next, a specific example of RAID configuration change processing will be described.

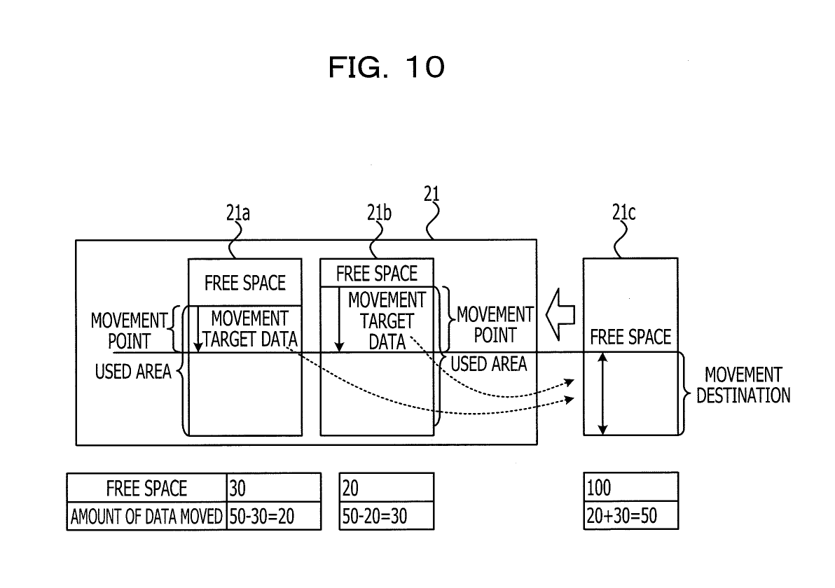

FIGS. 10 to 13 depict specific examples of RAID configuration change processing.

The RAID control unit 120 calculates the movement points of data of the HDDs 21a and 21b from which data is moved using a finally-created RAID configuration specified by the designer. In this specific example, RAID4 (3+1), which is obtained by addition of one HDD 21c to the RAID group 21, is assumed to be the RAID configuration after reconfiguration. In FIG. 10, the HDD P1 is not depicted. In this specific example, the storage capacities of the HDDs 21a, 21b, and 21c are assumed to be 100 GB. The storage capacity of the used area of the HDD 21a is assumed to be 70 GB and the storage capacity of the used area of the HDD 21b is assumed to be 80 GB. If the free areas of the HDDs 21a, 21b, and 21c after reconfiguration are calculated so that the free spaces of the HDDs 21a, 21b, and 21c are equalized, the free areas are (30+20+100)/3=50 GB. Accordingly, the amount of data moved from the HDD 21a is calculated by (free areas of HDDs 21a, 21b, and 21c after reconfiguration)−(current free area)=50−30=20 GB. The amount of data moved from the HDD 21b is calculated by 50−20=30 GB. The amount of data written to the HDD 21c is calculated by 20+30=50 GB.

Next, the RAID control unit 120 checks the number of spare disks in the spare disk pool A1. The number is assumed to be 4 in this specific example.

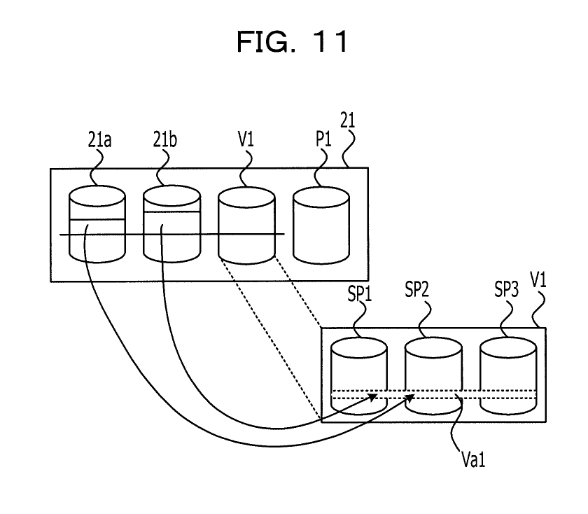

Next, the RAID control unit 120 creates one virtual disk V1 including three spare disks SP1, SP2, and SP3 according to the given number of spare disks (three spare disks), as depicted in FIG. 11. The RAID control unit 120 initializes the virtual disk V1 and incorporates it into the RAID group 21. Then, the RAID control unit 120 reports, to the server apparatus 30 that uses the RAID group 21, the incorporation of the virtual disk V1 into the RAID group 21. When receiving the report, the server apparatus 30 updates the bitmap table managed by the file system 31 so that the free space (the area excluding the movement destination) is expanded. The file system 31 manages the free space separately from the data movement destination during data migration. The incorporation of the virtual disk V1 into the RAID group 21 may be reported to the server apparatus 30 even after completion of data migration.

Next, the RAID control unit 120 performs data migration to move the data stored in the movement points of the HDDs 21a and 21b to a move destination storage area Val in the spare disks SP1, SP2, and SP3 in a distributed manner. The storage area Val is an example of the second storage area. The storage capacity of the storage area Val is 50 GB, which corresponds to the amount of data written to the HDD 21c. The movement of data is performed in units of logical blocks.

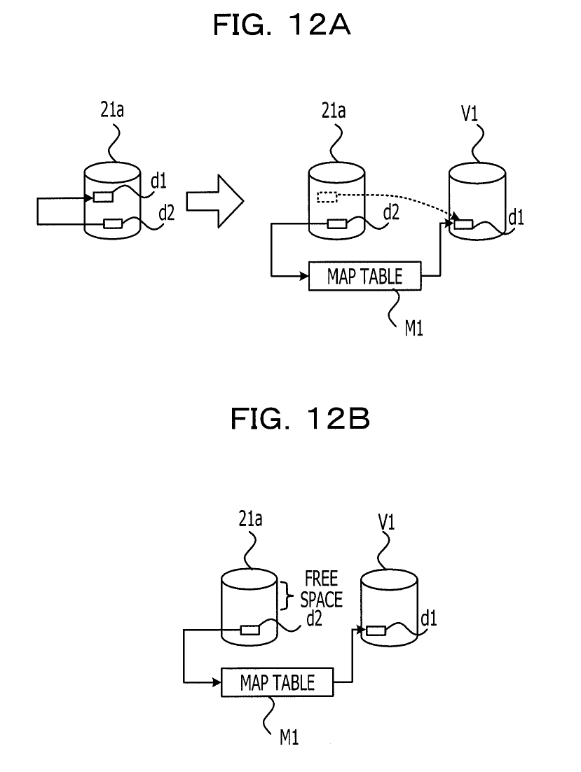

The RAID control unit 120 uses a map table M1 to manage the correspondence between movement source logical block addresses and movement destination logical block addresses so that, even after moving data d1 in a movement point to the virtual disk V1, it is possible to reference the moved data d1 from d2, which is not moved, as depicted in FIG. 12A. In FIG. 12A, the HDD 21b is not depicted. The map table M1 is deleted when the file system is created again.

As depicted in FIG. 12B, upon completion of data migration, the RAID control unit 120 reports, to the server apparatus 30, that the areas of movement points requested by the HDDs 21a and 21b are changed to free spaces on a management basis. As described above with reference to FIG. 7, when receiving this report, the server apparatus 30 sets the bit corresponding to the area of the movement point in the bitmap table to 0, which indicates a state in which a free space is expanded.

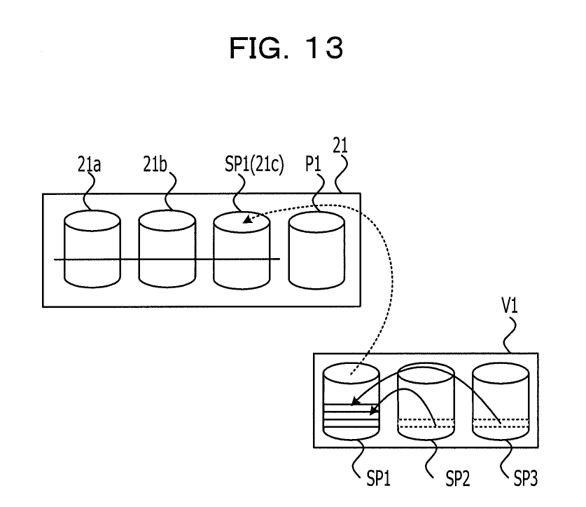

Next, the RAID control unit 120 collects the data written to the virtual disk V1 in one (the spare disk SP1 in FIG. 13) of the spare disks SP1, SP2, and SP3 constituting the virtual disk V1, as depicted in FIG. 13. The spare disk SP1 is the HDD 21c described above. After collecting the data, the RAID control unit 120 incorporates the spare disk SP1 in which the data has been collected into the RAID group 21 in place of the virtual disk V1. With this, the RAID control unit 120 configures RAID4 that uses the HDDs 21a and 21b, the spare disk SP1 (HDD 21c), and the HDD P1.

Next, the RAID control unit 120 returns, to the spare disk pool A1, the spare disks SP2 and SP3 were not incorporated into the RAID group 21 of the used spare disks SP1, SP2, and SP3. In the second embodiment, the magnetic tape 61 is not assigned to the storage area of the virtual disk. When the magnetic tape 61 is assigned to the virtual disk, however, the exclusive state of the magnetic tape 61 is released.

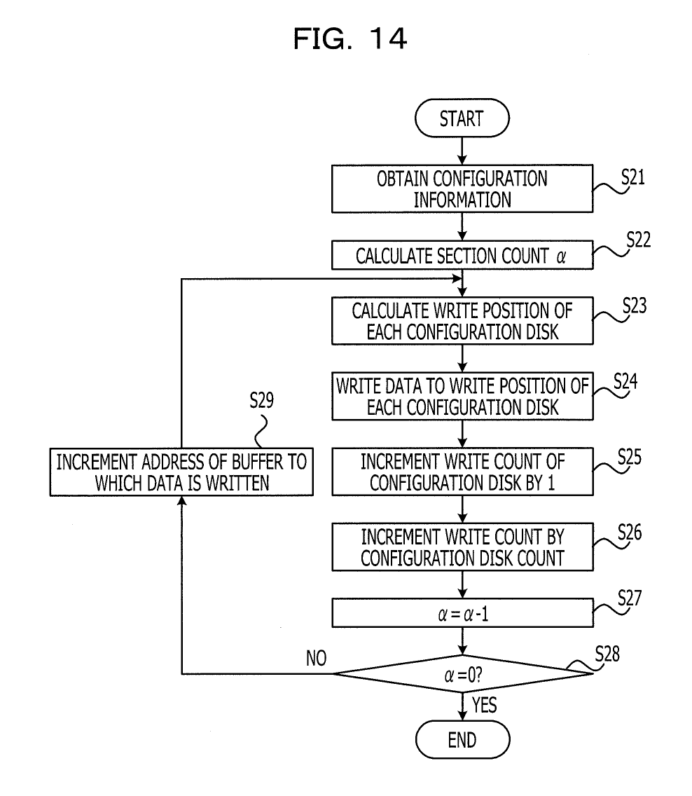

Next, data migration in step S9 in FIG. 9 will be described in detail. In data migration, the RAID control unit 120 basically carries out processing during writing of data depicted in FIG. 14. When the RAID control unit 120 receives a release request to release a part of configuration disks of the virtual disk of the file system 31 in processing during writing of data, the RAID control unit 120 carries out disk release processing. When the RAID control unit 120 receives an addition request to add a spare disk to the virtual disk of the file system 31 in processing during writing of data, the RAID control unit 120 carries out disk addition processing. The processing during writing of data will be described in sequence.

FIG. 14 is a flowchart depicting processing during writing of data.

[Step S21] The RAID control unit 120 obtains the configuration information of a virtual disk from a process target entry in the control table 121. If there are a plurality of entries, the entry with the largest entry ID becomes the process target entry. Then, the processing proceeds to step S22.

[Step S22] The RAID control unit 120 reads the total number of data items stored in the movement points and to a buffer. The buffer is, for example, an area in the cache memory 104. Then, the RAID control unit 120 divides the total number of data items stored in the butter by the sum of the write sizes of the configuration disks with reference to the control table 121 to obtain a section count α. For example, when the total number of data items stored in the movement points is 90 and the sum of the write sizes of the configuration disks is 3, the section count α is 90/3=30. Then, the processing proceeds to step S23.

[Step S23] The RAID control unit 120 calculates the write position in each of the configuration disks by “write start position”+“write size”×“configuration disk count”×“write count”. Then, the processing proceeds to step S24.

[Step S24] The RAID control unit 120 writes the data divided by the configuration disk count, separates it for each configuration disk, and writes it to the write positions in the configuration disks calculated in step S23. Then, the processing proceeds to step S25.

[Step S25] Upon completion of writing to each configuration disk in step S24, the RAID control unit 120 increments the value in the write count field of each configuration disk in control table 121, by 1. Then, the processing proceeds to step S26.

[Step S26] Upon completion of writing to all configuration disks, the RAID control unit 120 increments the value stored in the total write count in the control table 121 by the value in the configuration disk count field. Then, the processing proceeds to step S27.

[Step S27] The RAID control unit 120 decrements the section count α by 1. Then, the processing proceeds to step S28.

[Step S28] The RAID control unit 120 decides whether the section count α is 0. When the section count α is 0 (Yes in step S28), the process in FIG. 14 ends. When the section count α is not 0 (No in step S28), the processing proceeds to step S29.

[Step S29] The RAID control unit 120 increments the address of a buffer to which data is written by the sum of the write sizes of the configuration disks. Then, the processing proceeds to step S23 and the process beginning with step S23 is carried out. The description of the process in FIG. 14 is completed.

Next, a specific example of processing during writing of data will be described. The specific example below assumes that the total number of data items in blocks stored in the movement points is 90.

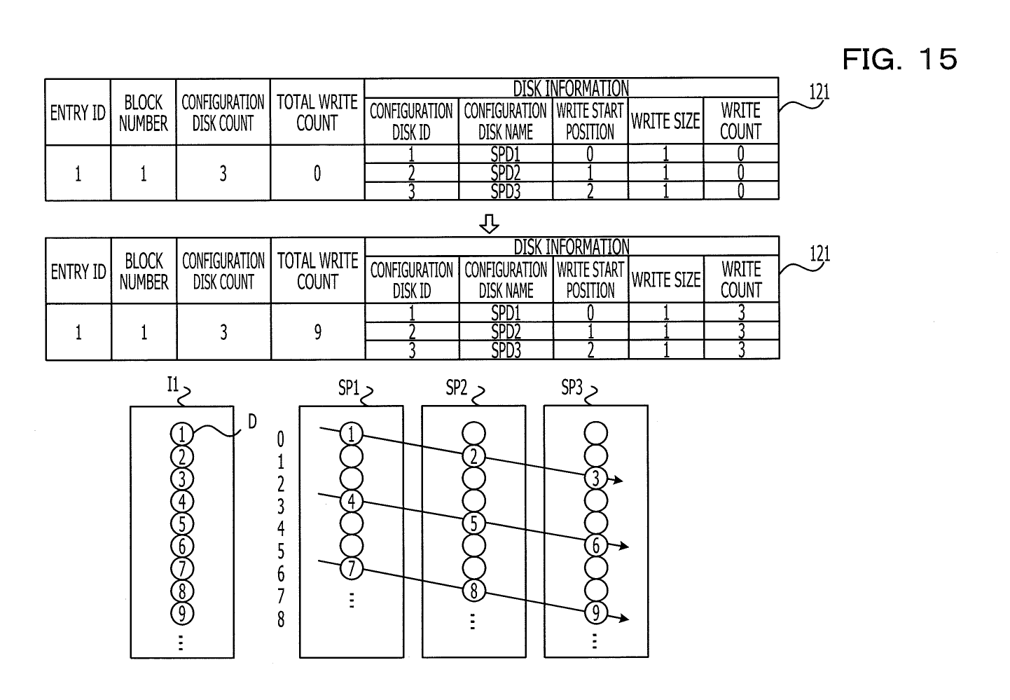

FIG. 15 describes the specific example of the processing during writing of data.

The RAID control unit 120 reads the total number of data items in units of blocks stored in the movement points to a buffer. FIG. 15 depicts a logical image I1 of the virtual disk V1 read to the buffer. In the logical image I1, data D is arranged in units of logical blocks. A value in data D is described for explanatory purposes.

The RAID control unit 120 prepares the control table 121 related to writing of data to the spare disks SP1, SP2, and SP3 included in the virtual disk V1. The control table 121 in the upper part of FIG. 15 depicts the prepared control table. In the following descriptions, the disk name of the spare disk SP1 is assumed to be SPD1, the disk name of the spare disk SP2 is assumed to be SPD2, and the disk name of the spare disk SP3 is assumed to be SPD3.

The RAID control unit 120 shifts each of the write start positions of the configuration disks by one position. Then, the RAID control unit 120 calculates the section count α as 90/3=30 because the total number of data items stored in the movement points is 90 and the sum of the write sizes of the configuration disks is 3.

Next, the RAID control unit 120 calculates the write position in the spare disk SP1 by “write start position”+“write size”×“configuration disk count”×“write count”=0+1×3×0=0. Similarly, the write position of the spare disk SP1 is calculated by “write start position”+“write size”×“configuration disk count”×“write count”=1+1×3×0=1. The write position in the spare disk SP3 is calculated by “write start position”+“write size”×“configuration disk count”×“write count”=2+1×3×0=2.

Next, the RAID control unit 120 writes the data divided by the configuration disk count 3, separates it for each write size into the spare disks SP1, SP2, and SP3, and writes it to the calculated write positions in the spare disks SP1, SP2, and SP3. Upon completion of the writing, the RAID control unit 120 increments the values in the write count fields for the spare disks SP1, SP2, and SP3 in the control table 121, by 1. With this, the values in the write count fields for the spare disks SP1, SP2, and SP3 change from 0 to 1. Upon completion of writing to all configuration disks, the RAID control unit 120 increments the value in the total write count field in the control table 121 by 3, which is set in the configuration disk count field. With this, the value in the total write count field changes from 0 to 3.

Next, the RAID control unit 120 decrements the value of the section count α by 1 to 29. Since the value of the section count α is not 0, the address of the buffer to which data is written is incremented by 3, which is the sum of the write sizes of the configuration disks.

Next, the RAID control unit 120 calculates the write position in the spare disk SP1. The write position is calculated by “write start position”+“write size”×“configuration disk count”×“write count”=0+1×3×1=3. Similarly, the write position in the spare disk SP2 is calculated by “write start position”+“write size”×“configuration disk count”×“write count”=1+1×3×1=4. The write position in the spare disk SP2 is calculated by “write start position”+“write size”×“configuration disk count”×“write count”=2+1×3×1=5. Then, the RAID control unit 120 carries out data migration until the section count αequals 0.

The control table 121 in the lower part of FIG. 15 depicts the state in which the blocks 1 to 10 of data D have been processed.

The RAID control unit 120 shifts the write positions in the configuration disks by carrying out data migration. This facilitates the collection of data in step S12. This also facilitates the saving of data during disk release processing, which will be described below.

Next, disk release processing will be described.

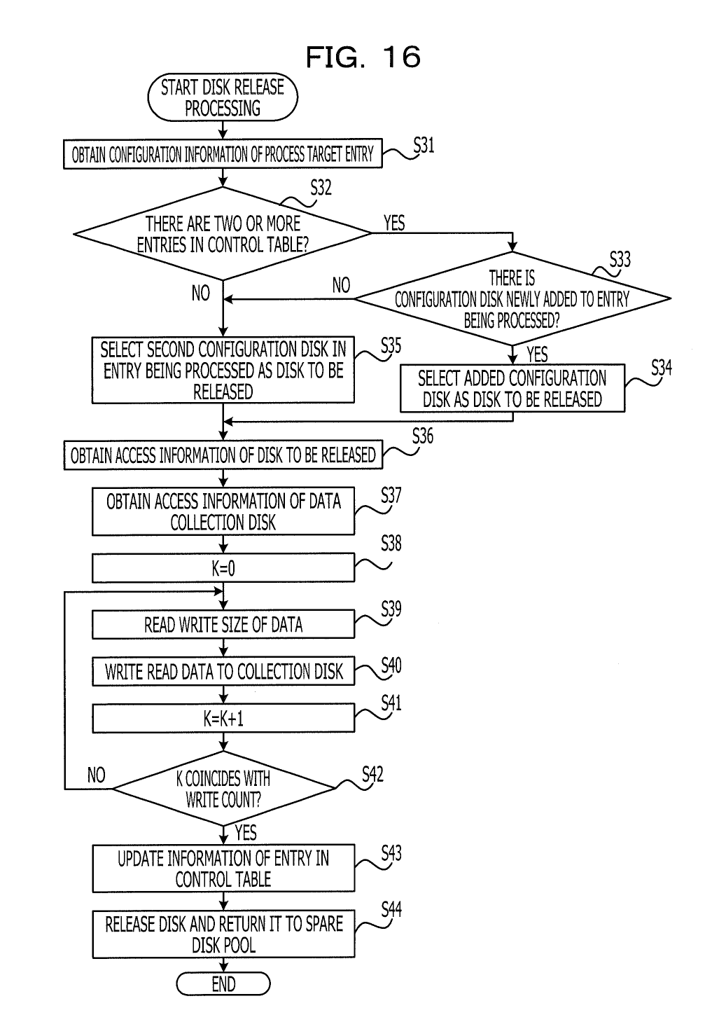

FIG. 16 is a flowchart depicting disk release processing.

[Step S31] The RAID control unit 120 obtains the configuration information of a virtual disk from the process target entry in the control table 121. Then, the processing proceeds to step S32. The RAID control unit 120 carries out the process of steps S32 to S35 to select the disk to be released from the configuration disks.

[Step S32] The RAID control unit 120 decides whether there are two or more entries, with reference to the entry ID field in the control table 121. When there are two or more entries (Yes in step S32), the processing proceeds to step S33. When there are not two or more entries, that is, when there is one entry (No in step S32), the processing proceeds to step S35.

[Step S33] The RAID control unit 120 decides whether there is a configuration disk newly added to the process target entry. For example, the RAID control unit 120 compares the value in the configuration disk count field in the process target entry with the value in the configuration disk count field in the entry with the entry ID immediately before the entry ID of the process target entry. When the value in the configuration disk count field in the process target entry is different from the value in the configuration disk count field in the entry with the entry ID immediately before the entry ID of the process target entry, the RAID control unit 120 decides that there is a configuration disk newly added to the process target entry. When there is a configuration disk newly added to the process target entry (Yes in step S33), the processing proceeds to step S34. When there is not a configuration disk newly added to the process target entry (No in step S33), the processing proceeds to step S35. In the process in step S33, the configuration disk with the minimum amount of data stored may be selected as the disk to be released. This may reduce the amount of data to be moved, which will be described below.

[Step S34] The RAID control unit 120 selects the configuration disk newly added, as the disk to be released. Then, the processing proceeds to step S36.

[Step S35] The RAID control unit 120 selects the configuration disk with a configuration disk ID of 2 in the process target entry as the disk to be released. Then, the processing proceeds to step S36.

[Step S36] The RAID control unit 120 obtains access information of the disk to be released that is selected in step S34 or step S35 with reference to the control table 121. Then, the processing proceeds to step S37.

[Step S37] The RAID control unit 120 decides the configuration disk with a configuration disk ID smaller than the configuration disk ID of the configuration disk to be released by 1, as the disk to which data is saved. For example, when the configuration disk with a configuration disk ID of 2 is selected as the disk to be released, the RAID control unit 120 decides the configuration disk with a configuration disk ID of 1 as the disk to which data is saved. The disk to which data is saved is referred to below as the data save destination disk. Then, the RAID control unit 120 obtains access information for the data save destination disk. Then, the processing proceeds to step S38.

[Step S38] The RAID control unit 120 prepares a parameter K, which indicates the number of data read operations from the disk to be released to the data save destination disk, and sets K to 0. Then, the processing proceeds to step S39.

[Step S39] The RAID control unit 120 reads the data that was written from the disk to be released by calculating “write start position” of the disk to be released+K×“configuration disk count”. Then, the processing proceeds to step S40.

[Step S40] The RAID control unit 120 writes the data that was read in step S39 to the area of the data save destination disk identified by “write start position”+1+K×“configuration disk count”. Then, the processing proceeds to step S41.

[Step S41] The RAID control unit 120 increments K by 1. Then, the processing proceeds to step S42.

[Step S42] The RAID control unit 120 decides whether the value of K coincides with the value set in the write count field for the disk to be released in the control table 121. When the value of K coincides with the value set in the write count field for the disk to be released in the control table 121 (Yes in step S42), the processing proceeds to step S43. When the value of K does not coincide with the value set in the write count field for the disk to be released in the control table 121 (No in step S42), the processing proceeds to step S39 and the process beginning with step S39 is carried out.

[Step S43] The RAID control unit 120 updates information of the process target entry. For example, the RAID control unit 120 deletes the record related to the disk to be released in the control table 121. In addition, the RAID control unit 120 increments the value set in the write size field of the data save destination disk in the control table 121, by 1. The RAID control unit 120 decrements the value in the configuration disk count field in the control table 121, by 1. Then, the processing proceeds to step S44.

[Step S44] The RAID control unit 120 returns the disk to be released to the spare disk pool A1. Then, the process in FIG. 16 ends.

Next, a specific example of disk release processing will be described.

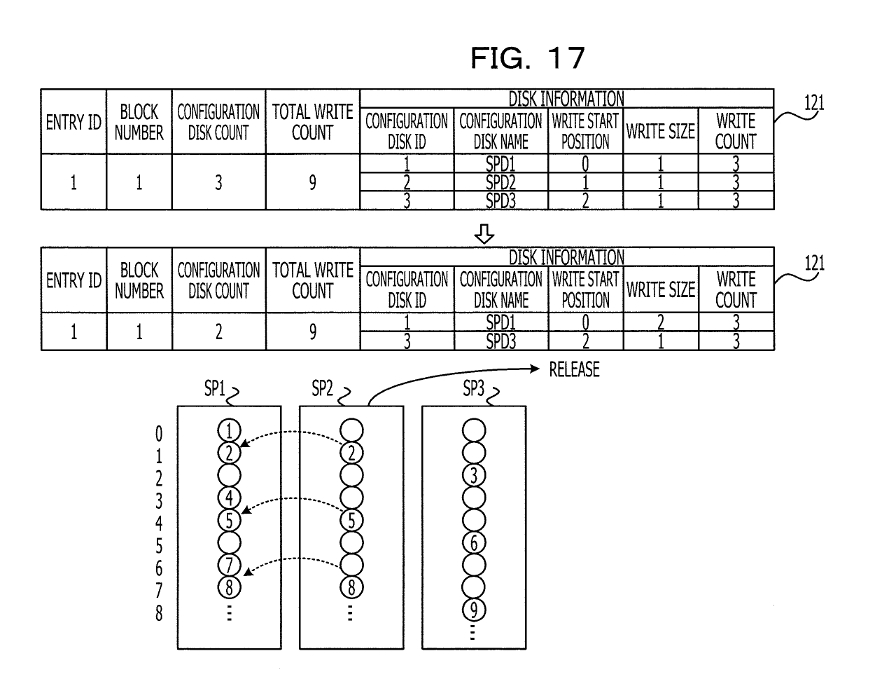

FIG. 17 describes a specific example of the disk release processing.

This specific example describes processing when a release request to release one spare disk is received in the state of the control table 121 in the upper part of FIG. 17, that is, at the time when writing of blocks 1 to 9 of data D to the virtual disk V1 has been performed.

The RAID control unit 120 decides whether there are two or more entries, with reference to the entry ID field in the control table 121. Since there is one entry in this specific example, the spare disk SP2 identified by the configuration disk ID 2 is selected as the disk to be released.

Next, the RAID control unit 120 decides, as the data save destination disk, the spare disk SP1 identified by the configuration disk ID 1, which is smaller than the configuration disk ID of the disk to be released by 1.

Next, the RAID control unit 120 reads data with the write size from the spare disk SP2 by setting the parameter K to 0 and calculating “write start position”+K×“configuration disk count”=1+0×3=1 for the spare disk SP2. Then, the RAID control unit 120 writes the read data to the area of the spare disk SP1 identified by “write start position”+1+K×“configuration disk count”=0+1+0×3=1. After that, the RAID control unit 120 sets K to 1. Since the value of K does not coincide with the value 3 in the write count field in the control table 121, the RAID control unit 120 reads data with the write size from the spare disk SP2 by calculating “write start position”+K×“configuration disk count”=1+1×3=4. Then, the RAID control unit 120 repeats data migration until K equals 3. When K equals 3, the record with an entry ID of 1 and a configuration disk ID of 2 in the control table 121 is deleted. Then, the value in the write count field with a configuration disk ID of 1 is incremented by 1 to 2. Then, the value in the configuration disk count field is decremented by 1 to 2. The control table 121 in the lower part of FIG. 17 depicts the state when disk release processing is completed.

Next, the RAID control unit 120 returns the spare disk SP2 to the spare disk pool A1. Then, the RAID control unit 120 continues data migration using the control table 121 in the lower part of FIG. 17.

Next, disk addition processing will be described.

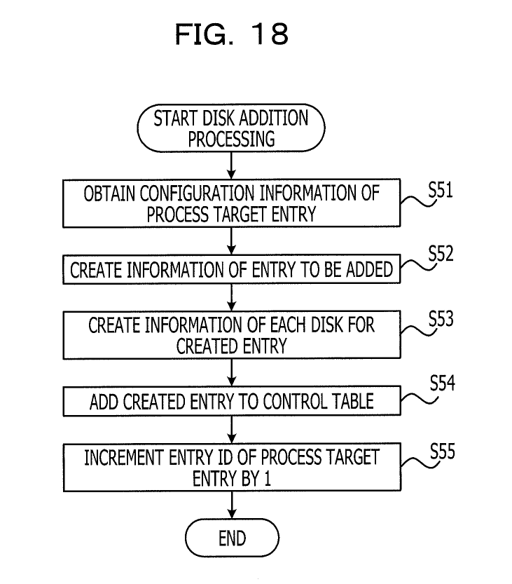

FIG. 18 is a flowchart depicting disk addition processing.

[Step S51] The RAID control unit 120 obtains the configuration information of a virtual disk from the process target entry. Then, the processing proceeds to step S52.

[Step S52] The RAID control unit 120 sets the block number, configuration disk count, and total write count of a new entry to be added. For example, the RAID control unit 120 sets the block number β of the new entry to “block number” of the process target entry+“total write count” of the process target entry. The RAID control unit 120 also sets the configuration disk count of the new entry to “configuration disk count” of the process target entry+1. The RAID control unit 120 also sets the total write count of the new entry to 0. Then, the processing proceeds to step S53.

[Step S53] The RAID control unit 120 creates the disk information of the new entry. For example, the RAID control unit 120 copies the disk information of the process target entry to the new entry. Then, the RAID control unit 120 adds, to the new entry, the configuration disk ID and configuration disk name, which are disk information to be added. Then, the RAID control unit 120 sets the information of each disk. For example, the RAID control unit 120 sets the “write size” disk information to 1 and the “write count” disk information to 0. The RAID control unit 120 decides the write start positions of the write the configuration disks. For example, the RAID control unit 120 sets “write start position” to “configuration disk ID”−1 for the write start position of a disk to be added. The RAID control unit 120 also sets “write start position” to α+“configuration disk ID”−1 for the write start position of an existing configuration disk. Then, the processing proceeds to step S54.

[Step S54] The RAID control unit 120 adds the created new entry to the control table 121. Then, the processing proceeds to step S55.

[Step S55] The RAID control unit 120 increments the entry ID of the process target entry by 1. This process lets the added entry become the process target entry. Then, the process in FIG. 18 ends.

Next, a specific example of disk addition processing will be described.

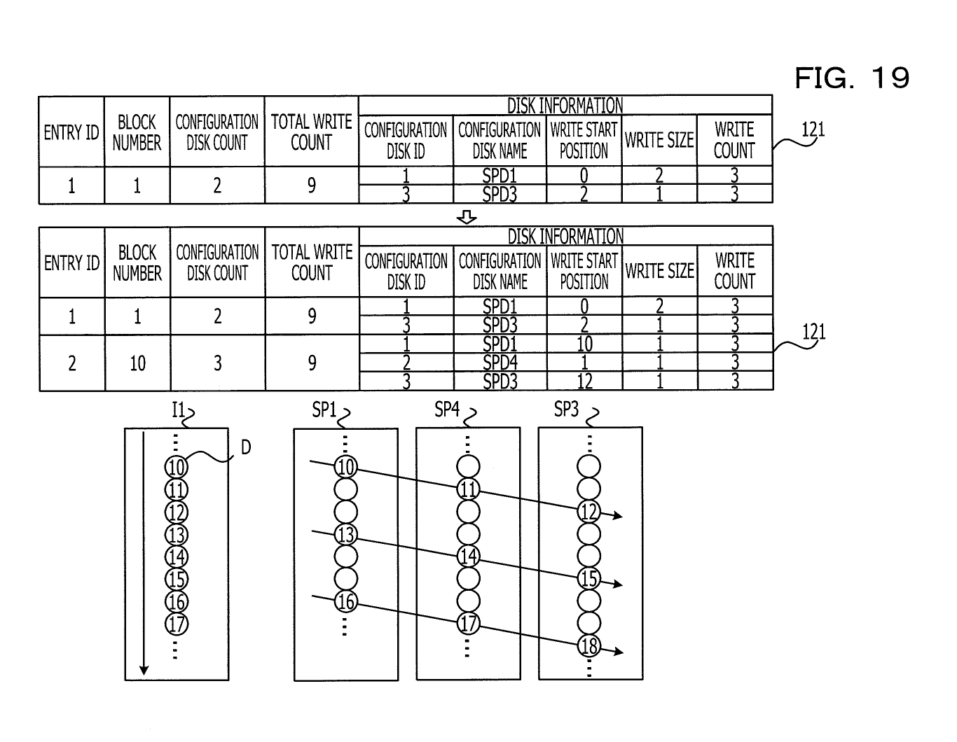

FIG. 19 describes a specific example of the disk addition processing.

This specific example describes processing when an addition request to add one spare disk is received at the time when writing of data to the virtual disk V1 has been performed until the state of the control table 121 in the upper part of FIG. 19 is reached.

The RAID control unit 120 obtains configuration information from the entry with an entry ID of 1. Then, the RAID control unit 120 sets the block number 13 of the new entry to “block number” of the process target entry+“total write count” of the process target entry=1+9=10. The RAID control unit 120 also sets the configuration disk count of the new entry to “configuration disk count” of the process target entry+1=2+1=3. It also sets “total write count” of the new entry to 0.

Next, the RAID control unit 120 copies the disk information of the entry with an entry ID of 1 to the created entry as its disk information. Then, the RAID control unit 120 sets the “write size” disk information to 1 and the “write count” disk information to 0.

Next, the RAID control unit 120 sets “write start position” of a spare disk SP4 to be added to “configuration disk ID”−1=2−1=1. The RAID control unit 120 also sets “write start position” of the spare disk SP 1 to β+“configuration disk ID”−1=10+1−1=10. The RAID control unit 120 also sets “write start position” of the spare disk SP3 to β+“configuration disk ID”−1=10+3−1=12.

Next, the RAID control unit 120 sets the entry ID of the new entry to 2 and specifies the entry with an entry ID of 2 as the process target entry.

Next, the process (data collection processing) in steps S12 and S13 in FIG. 9 will be described in detail below.

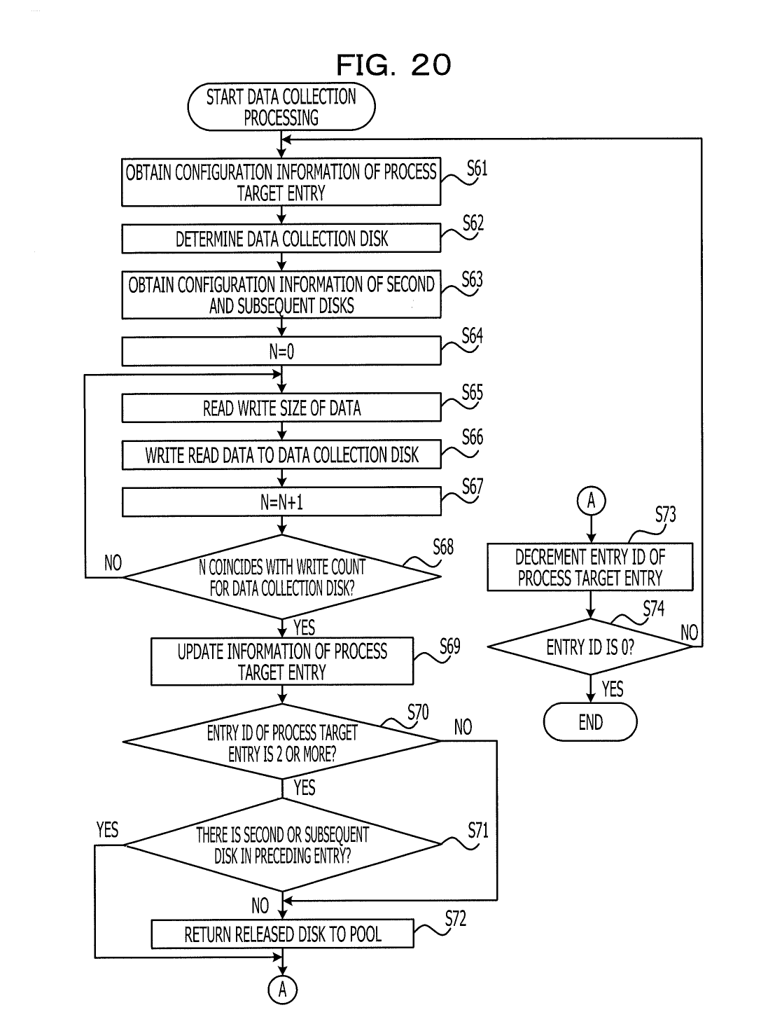

FIG. 20 is a flowchart depicting data collection processing.

[Step S61] The RAID control unit 120 obtains configuration information from the process target entry. Then, the processing proceeds to step S62.

[Step S62] The RAID control unit 120 obtains the configuration information of the configuration disk with the minimum configuration disk ID. This configuration disk is determined to be a data collection disk. The configuration disks other than the data collection disk are determined to be disks to be released. Then, the processing proceeds to step S63.

[Step S63] The RAID control unit 120 obtains the configuration information of the second and subsequent configuration disks. Then, the processing proceeds to step S64.

[Step S64] The RAID control unit 120 sets a parameter N to 0; parameter N indicates the number of data read operations from configuration disks to the data collection disk. Then, the processing proceeds to step S65.

[Step S65] The RAID control unit 120 calculates “write start position”+N×“configuration disk count” for the configuration disks other than the data collection disk to decide the data read position. Then, the RAID control unit 120 reads the write size of data, beginning with the decided data read position. Then, the processing proceeds to step S66.

[Step S66] The RAID control unit 120 collectively writes the data read in step S65 of the size specified by “configuration disk count”−1 to the position of the data collection disk specified by “write start position”+1+N×“configuration disk count”. Then, the processing proceeds to step S67.

[Step S67] The RAID control unit 120 sets N to N+1. Then, the processing proceeds to step S68.

[Step S68] The RAID control unit 120 decides whether N coincides with the value in the write count field for the data collection disk. When N coincides with the value in the write count field (Yes in step S68), the processing proceeds to step S69. When N does not coincide with the value in the write count field (No in step S68), the processing proceeds to step S65 and the process beginning with step S65 is carried out.

[Step S69] The RAID control unit 120 updates information in the process target entry. For example, the RAID control unit 120 replaces the value in the write size field of the data collection disk in the process target entry with the value in the configuration disk count field. Then, the RAID control unit 120 sets the value in the configuration disk count field to 1. Then, the RAID control unit 120 deletes the disk information of the disk to be released, from the entry. Then, the processing proceeds to step S70.

[Step S70] The RAID control unit 120 decides whether the entry ID of the process target entry is 2 or more. When the entry ID of the process target entry is 2 or more (Yes in step S70), the processing proceeds to step S71. When the entry ID of the process target entry is 1 (No in step S70), the processing proceeds to step S72.

[Step S71] The RAID control unit 120 decides whether there is disk information with a configuration disk ID of other than 1 in the entry followed by the process target entry. When there is disk information with a configuration disk ID of other than 1 in the entry followed by the process target entry (Yes in step S71), the processing proceeds to step S73. When there is not disk information with a configuration disk ID of other than 1 in the entry followed by the process target entry (No in step S71), the processing proceeds to step S72.

[Step S72] The RAID control unit 120 releases the configuration disks with a configuration disk ID of other than 1 and returns them to the spare disk pool A1. Then, the processing proceeds to step S73.

[Step S73] The RAID control unit 120 decrements the entry ID of the process target entry by 1. Then, the processing proceeds to step S74.

[Step S74] The RAID control unit 120 decides whether the entry ID of the process target entry is 0. When the entry ID of the process target entry is 0 (Yes in step S74), the process in FIG. 20 ends. When the entry ID of the process target entry is not 0 (No in step S74), the processing proceeds to step S61 and the process beginning with step S61 is carried out. Now, the description of data collection processing ends.

As described above, the storage apparatus 100 may continue data migration while responding to a release request to release a spare disk included in the virtual disk V1. This reduces data migration time. In addition, data is written to the spare disks SP1, SP2, and SP3 with their write positions shifted, disk release processing or disk addition processing may be carried out immediately without interrupting data migration.

The process carried out by the control module 10 may be distributed among a plurality of control modules.

Although the controller, program, and storage apparatus according to the present disclosure are described above based on the embodiments depicted in the drawings, the present disclosure is not limited to these embodiments and the structure of each component may be replaced with any structure having the same function. Any other structures or processes may be added to the present disclosure.

The present disclosure may be combination of any two or more structures or characteristics of the embodiments described above.

The above processing function may be implemented by a computer. In this case, a program describing the processing by the functions of the controller 2 and the control module 10 is provided. The computer executes the program to achieve the above processing function on the computer. The program describing the processing may be recorded in a computer-readable recording medium. Examples of a computer-readable recording medium include a magnetic recording device, optical disc, magneto-optical recording medium, and semiconductor memory. Examples of a magnetic recording device include a hard disk drive, flexible disk (FD), and magnetic tape. Examples of an optical disc include DVD, DVD-RAM, and CD-ROM/RW. Examples of a magneto-optical recording medium include a MO (magneto-optical disc).

When the program is put into circulation, a portable recording medium containing the program, such as a DVD or CD-ROM is marketed. Alternatively, the program may be stored in a storage device in the server computer and the program may be transferred from the server computer to another computer via a network.

The computer that executes the program stores, in its storage device, the program stored in a portable recording medium or transferred from the server computer. Then, the computer reads the program from its storage device and performs processing according to the program. The computer may read the program directly from the portable recording medium and may perform processing according to the program. The computer may sequentially perform processing according to a part of the program transferred from the server computer via a network each time the part of program is transferred from the server computer coupled.

At least a part of the above processing function may be implement by an electronic circuit such as a DSP (digital signal processor), ASIC (application specific integrated circuit), PLD (programmable logic device), etc.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A controller comprising:
a memory that stores a program; and
a processor that executes, based on the program, a procedure comprising;
recording migration data from a source to a destination assigned to a plurality of storages based on information for indicating a position of a recording area which is between areas in which data is recorded in units of blocks;
receiving a request to release at least one of the plurality of storages during data migration and migrating recorded data recorded in the at least one of the plurality of storages to other recording area formed in other storages of the plurality of storages; and
releasing the at least one of the plurality of storages after migrating the recorded data.

2. The controller according to claim 1,
wherein the recording area is set depending on the number of the plurality of storages assigned to the destination.

3. The controller according to claim 1,
wherein the position of the recording area differs for each of the plurality of storages assigned to the destination.

4. The controller according to claim 1,
wherein, when the request is received, the information is rewritten depending on the number of the other storages of the plurality of storages.

5. The controller according to claim 1,
wherein, when an addition request to add a storage assigned to the destination is received during data migration, the information is rewritten depending on the number of the storages including the added storage.

6. The controller according to claim 5,
wherein, when the request is received, the added storage of the storages assigned to the destination is determined to be released.

7. The controller according to claim 1,
wherein, when the migration data has been migrated to the destination, the migrated data is collected in the at least one of the plurality of storages assigned to the destination.

8. The controller according to claim 1,
wherein the information is created depending on the number of the storages assigned to the destination.

9. The controller according to claim 1,
wherein the destination includes a tape storage.

10. A computer-readable recording medium having stored therein a program for causing a client apparatus to execute a digital signature process comprising:
recording migration data from a source to a destination assigned to a plurality of storages based on information for indicating a position of a recording area which is between areas in which data is recorded in units of blocks;
receiving a request to release at least one of the plurality of storages during data migration and migrating recorded data recorded in the at least one of the plurality of storages to other recording area formed in other storages of the plurality of storages; and
releasing the at least one of the plurality of storages after migrating the recorded data.

11. The computer-readable recording medium according to claim 10,
wherein the recording area is set depending on the number of the plurality of storages assigned to the destination.

12. The computer-readable recording medium according to claim 10,
wherein the position of the recording area differs for each of the plurality of storages assigned to the destination.

13. The computer-readable recording medium according to claim 10,
wherein, when the request is received, the information is rewritten depending on the number of the other storages of the plurality of storages.

14. The computer-readable recording medium according to claim 10,
wherein, when an addition request to add a storage assigned to the destination is received during data migration, the information is rewritten depending on the number of the storages including the added storage.

15. An apparatus comprising:
at least one storage assigned to a source;
a plurality of storages assigned to a destination; and
a controller comprising a memory that stores a program, and a processor that executes, based on the program, a procedure;
the procedure comprises:
recording migration data from a source to a destination assigned to a plurality of storages based on information for indicating a position of a recording area which is between areas in which data is recorded in units of blocks;
receiving a request to release at least one of the plurality of storages during data migration and migrating recorded data recorded in the at least one of the plurality of storages to other recording area formed in other storages of the plurality of storages; and
releasing the at least one of the plurality of storages after migrating the recorded data.

16. The apparatus according to claim 15,
wherein the recording area is set depending on the number of the plurality of storages assigned to the destination.

17. The apparatus according to claim 15,
wherein the position of the recording area differs for each of the plurality of storages assigned to the destination.

18. The apparatus according to claim 15,
wherein, when the request is received, the information is rewritten depending on the number of the other storages of the plurality of storages.

19. The apparatus according to claim 15,
wherein, when an addition request to add a storage assigned to the destination is received during data migration, the information is rewritten depending on the number of the storages including the added storage.

20. The apparatus according to claim 19,
wherein, when the request is received, the added storage of the storages assigned to the destination is determined to be released.
